(19) United States
(12) Patent Application Publication
(10) Pub. No.: US 2015/0206515 A1
(43) Pub. Date: Jul. 23, 2015

(54) PICKGUARD ASSEMBLY FOR STRINGED INSTRUMENT HAVING ELECTRONIC DISPLAY

(71) Applicant: MW Ventures, LLC, Germantown, TN (US)

(72) Inventor: Mark D. Waugh, Germantown, TN (US)

(21) Appl. No.: 14/599,812

(22) Filed: Jan. 19, 2015

Related U.S. Application Data
(60) Provisional application No. 61/929,758, filed on Jan. 21, 2014.

(51) Int. Cl. G10D 1/08; G06F 3/0488; G06F 3/041

(52) U.S. Cl. CPC G10D 1/085; G06F 3/0412; G06F 3/0488

(57) ABSTRACT

A pickguard assembly attached to a body of a stringed instrument, such as a guitar, where the pickguard assembly protects the stringed instrument body and includes an electronic display. The electronic display allows a user to electronically control the visual appearance of the stringed instrument without having to physically remove or change the pickguard assembly.

### RELATED APPLICATIONS

This application claims the benefit of U.S. Provisional Application No. 61/929,758 filed on Jan. 21, 2014, the entire contents of which are incorporated herein.

### FIELD

The present disclosure generally relates to pickguards for guitars and other stringed instruments and, in particular, to pickguards having electronic displays or other light emitting devices.

### BACKGROUND

Pickguards for stringed instruments provide protection from possible damage that may occur when the instrument is strummed, and pickguards also contribute to the overall look of the instrument. Depending on the particular instrument and the pickguard, it may be difficult to change the pickguard in order to provide a new look for the instrument. For example, the pickguard might be attached with a joining mechanism that requires significant effort to remove and replace. Accordingly, providing a pickguard with an electronic display or other light emitting device can allow a user to vary the appearance of the instrument without removing the pickguard.

### SUMMARY

According to one embodiment, there is provided a pickguard assembly for a stringed instrument. The pickguard assembly comprises an electronic display with an electronic display screen coupled to and driven by electronic display circuitry, and mounting features for attaching the electronic display to a body of the stringed instrument. The pickguard assembly protects the stringed instrument body and is configured to electronically change its visual appearance.

According to another embodiment, there is provided a method of controlling the visual appearance of a stringed instrument. The method comprising the steps of: displaying a first image on an electronic display of a pickguard assembly attached to the stringed instrument; receiving an electronic input to change the visual appearance of the pickguard assembly; and displaying a second image on the electronic display of the pickguard assembly in response to the electronic input. The first and second images are different so that the visual appearance of the stringed instrument changes without physically replacing the pickguard assembly. The electronic input may be provided by a user, a user device, electronic display circuitry, electronic circuitry in the stringed instrument itself, or some other source, for example, as is subsequently described in more detail.

### DRAWINGS

Exemplary embodiments of the invention will hereinafter be described in conjunction with the appended drawings, wherein like designations denote like elements, and wherein:

FIG. 1 shows an exemplary pickguard assembly installed on an acoustic guitar;

FIG. 2 shows an exemplary pickguard assembly installed on an electric guitar; and

FIG. 3 shows an exemplary electronic display that may be used with the pickguard assemblies of FIG. 1 or 2.

### DESCRIPTION

A pickguard is a thin, flat piece that is oftentimes attached to a stringed instrument, such as a guitar, in the area of the strings in order to protect the instrument's finish from scratches or other damage that can be caused by a plectrum during strumming Pickguards, also known as scratchplates, are often made of materials that have contrasting colors to that of the underlying instrument body so that they contribute to the aesthetic or decorative nature of the instrument. Some instruments have replaceable pickguards, while others have ones that are permanently affixed to the instrument and, thus, are not replaceable. For those instruments having replaceable pickguards, it was traditionally necessary to remove an old pickguard and install a new one if a musician wanted to change that piece, which could be a time consuming and inconvenient process. Therefore, a pickguard assembly for a guitar or other stringed instrument is described herein that includes an electronic display so that it can both protect the instrument and provide for easy aesthetic changes without needing to manually replace the entire pickguard. The electronic display provides a musician with the ability to select from an infinite number of designs, patterns, colors, images, icons, symbols, or even dynamic animation or videos, with respect to the pickguard.

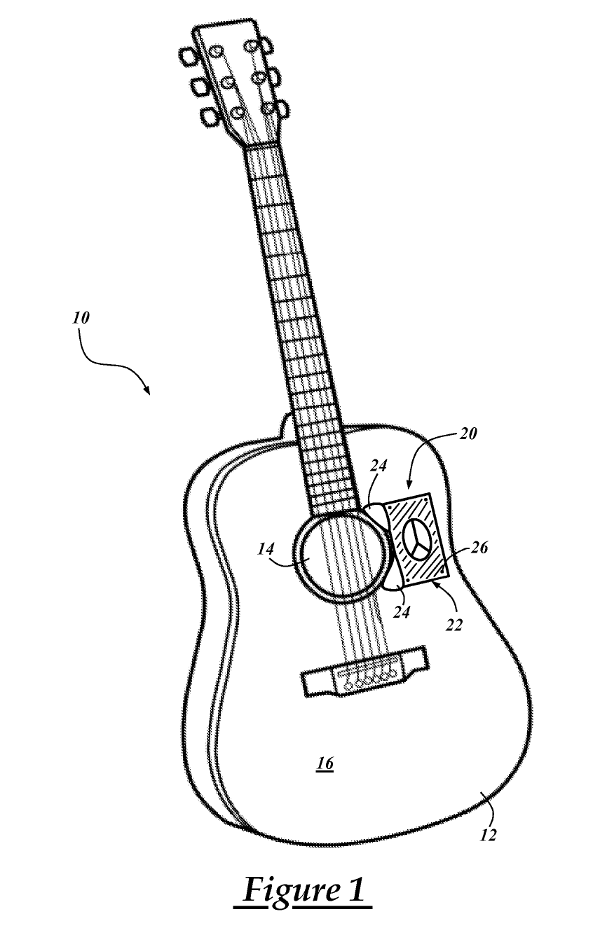

Referring to FIG. 1, there is shown an acoustic guitar 10 with an exemplary pickguard assembly 20 that is mounted thereto and includes an electronic display 22, complementary pickguard pieces 24, and mounting features 26. Pickguard assembly 20 may be mounted to a body 12 of the guitar and is preferably located so that it protects the body from damage by a guitar pick or plectrum during a down stroke of a musician's strum. In the example shown in FIG. 1, pickguard assembly 20 is mounted to the guitar body 12 at a traditional location that is adjacent a sound hole 14, however, the pickguard assembly could be mounted in any number of other suitable locations instead. Furthermore, pickguard assembly 20 may be designed as original equipment that is assembled with the rest of the guitar during manufacture or as after-market equipment that is retroactively attached or installed to the guitar at some later time. Although the following description is provided in the context of a guitar, it should be appreciated that pickguard assembly 20 may be designed for use with any type of plucked, picked or bowed stringed instrument and is not limited to the specific embodiments provided herein.

Electronic display 22 acts as both a protective surface and a visual display and may include an electronic display screen 30, electronic display circuitry 32, and an electronic display power source 34. Beginning with the electronic display screen 30, some non-limiting examples of potential display screens include those that use: liquid crystal displays (LCDs), light emitting diodes (LEDs), organic light emitting diodes (OLEDs), video graphics arrays (VGAs), plasma displays, printed displays, flexible displays, touch screens and/or other types of color or monochromatic displays. Depending on the particular embodiment, electronic display screen 30 may be configured to display or present different designs, patterns, colors, images, icons, symbols, or even dynamic animation or videos, to cite a few possibilities. For instance, electronic display 22 may include an LCD- or LED-type screen 30 that presents still images on a timed loop or cycle (e.g., the display screen cycles through a preselected collection of images on a periodic basis, such as the peace sign illustrated in FIG. 1). In another example, electronic display 22 may include an LCD- or LED-type screen 30 that displays animated images or video so that the pickguard exhibits a dynamic presentation as the musician is playing guitar 10 (e.g., the display screen presents a kaleidoscope of changing color patterns, or actual video footage of the musician performing). Because of the nature of an electronic display, as opposed to a simple pickguard made of wood or plastic, there are an infinite number of possible aesthetic appearances that may be achieved. It should be appreciated that the examples provided above are simply meant to illustrate some of the potential features and capabilities of electronic display 22 and are not meant to limit the scope of that device in any way. Other types of electronic displays and other technologies may certainly be used instead.

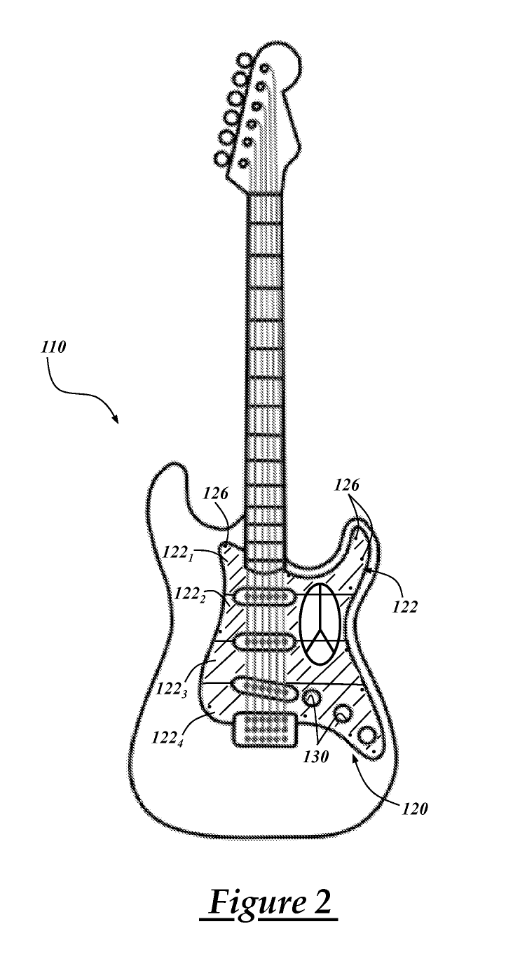

Electronic display screen 30 is shown in FIG. 1 as a simple rectangular component that is approximately the size of sound hole 14, however, this is not the only possibility. The exact shape and size of the electronic display screen may vary and may be customized to fit a particular guitar body. For example, it is possible for electronic display screen 30 to be square, circular, oval or some other shape in order to better fit the configuration of the guitar body 12 to which it is attached or the sound hole 14. It is also possible for the electronic display to be comprised of a number of smaller electronic display screens that are pieced together and functionally cooperate with one another in order to act as one big display. The size of the electronic display screen 30 may also vary and, depending on the particular application, it can be relatively small like the one shown in FIG. 1 or can be large enough to cover most, if not all, of the top surface 16 of guitar body 12. In other words, it is possible for the top surface 16 to be partially or entirely covered by the electronic display screen 30. It is further possible for electronic display screen 30 to include one or more openings or pass throughs so that guitar components, such as pickups, knobs, dials, switches, connectors, bridges, etc., can extend away from the guitar body 12 and through electronic display screen 30. Some examples of such openings are shown in FIG. 2 and are described in more detail below. Protective films or coatings may also be applied to the top surface of the electronic display screen 30 so that the screen is more resistant to scratching, scuffing or other damage. It should be appreciated that electronic display screen 30 is not limited to any particular size and shape, although some sizes and shapes, like that illustrated in FIG. 1, may be less expensive to manufacture than others.

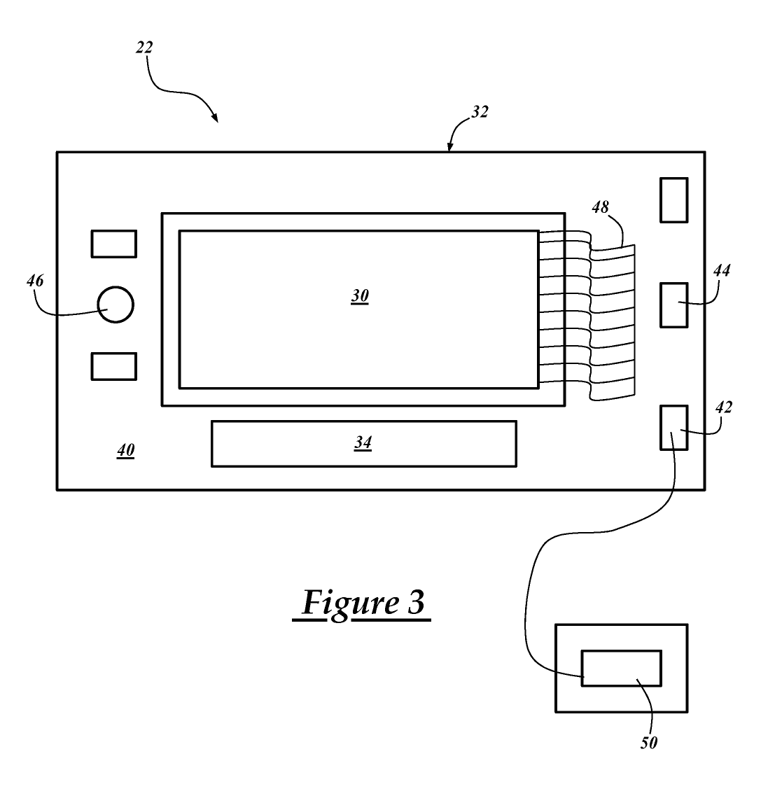

Electronic display circuitry 32 drives electronic display 22 and may include a printed circuit board (PCB) 40, a user input 42, an instrument interface 44 (this is generally for use with electric guitars, such as the one shown in FIG. 2), as well as a user switch 46, as illustrated in FIG. 3. Skilled artisans will appreciate that the technical details for the circuitry needed to drive or control an electronic display screen, such as an LCD- or LED-type display screen 30, are known in the art and thus are not repeated here. Moreover, electronic display 22 is not limited to any particular circuitry, so long as it is capable of controlling an electronic display screen 30 in the manner described herein. According to one potential embodiment, the software, firmware, scripts and/or other electronic instructions that are needed for implementing the functionality described herein are stored in electronic memory that is part of the electronic display circuitry 32 and may interact with electronic display screen 30 via ribbon cable 48. Skilled artisans will appreciate that shielding and other techniques may be needed in order to prevent electromagnetic interference (EMI) from the electronic display circuitry 32 from interfering with the operation of pickups or other components of an electric guitar, for example. Any suitable implementation of electronic display circuitry 32 may be employed.

User input 42 enables a musician to interact with electronic display 22 so that they can set up the images, video, etc. that they wish to display. For example, user input 42 may include a wired port 50 (e.g., a USB, microSD or other card slot) that receives the image or video files from a user device for display on electronic display screen 30. According to another example, user input 42 includes a wireless port that is configured to wirelessly interact with a user or user device (e.g., via BlueTooth, WiFi, etc.) so that the musician can wirelessly provide the electronic display 22 with the desired content for display. In either of the aforementioned examples, it is possible for the electronic content pertaining to the images, video, etc. to be “downloaded” and stored at the electronic display circuitry 32 before it is needed, or for the electronic content to be “streamed” to the electronic display circuitry in real time or nearly in real time, as it is required. In other examples, user input 42 allows a user to access the electronic display 22 with a mobile or stationary user device (e.g., a mobile phone, smart phone, tablet, laptop, personal computer, etc.) and to program the desired display accordingly; a corresponding “app” or other software may need to be installed on the user device for this functionality.

Instrument interface 44 is an optional component (primarily used with electric guitars, such as the one shown in FIG. 2) and is designed so that electronic display 22 may interact with the electronic circuitry or controls of the stringed instrument. In one example, instrument interface 44 couples the electronic display 22 to the output of one or more pickups on an electric guitar so that the visual presentation shown on the electronic display screen 30 is coordinated or synchronized with the operation of the electric guitar (e.g., display screen 30 could pulse, flash or cycle each time the musician strummed the guitar). The technical details of the instrument interface 44 will largely be dependent on the particular guitar or other instrument to which the pickguard assembly 20 is mounted, but any suitable interface known in the art may be used. For more information on the circuitry of certain guitars, please see http://www.electricalfun.com/workbenchfun/basic_electric_guitar_circuits.aspx and http://en.wikipedia.org/wiki/Guitar_wiring, which explain certain aspects of guitar circuits and wiring and are hereby incorporated by reference. Again, instrument interface 44 is not limited to any particular format, protocol, standard, etc.

User switch 46 is also an optional component and is designed to give the musician some control over electronic display 22. For instance, user switch 46 can be provided as a button, switch and/or other suitable control and can allow the musician to cycle to the next image, video, etc. so that they can control the visual presentation while they are playing the guitar. It is not necessary that user switch 46 be physically mounted on the PCB 40 itself, as it could instead be mounted on the guitar body 12, be wired or wirelessly connected to the electronic display via user input 42, or even be integrated within the electronic display screen 30. In one exemplary embodiment, the user switch 46 is part of a foot pedal that is wirelessly connected to the rest of the electronic display circuitry 32 so that the musician can control or manipulate the aesthetics of the electronic display 22 through activation of the foot pedal. In another embodiment, electronic display screen 30 is a touch screen and user switch 46 is integrated within the screen itself so that the musician can control the images or video being presented on screen 30 simply by engaging the screen itself

Electronic display power source 34 powers electronic display 22 and, depending on the embodiment, may receive its power from a local source like a battery or receive power from an external power source, like a standard 110 VAC outlet or the like. In the case of the acoustic guitar 10 shown in FIG. 1, the electronic display power source 34 will most likely include one or more batteries (e.g., rechargeable or simple replaceable batteries). If the pickguard assembly is installed on an electric guitar, such as the one illustrated in FIG. 2, then the electronic display power source 34 may include electrical connections that connect to a power bus or other connection within the electric guitar's wiring. Other embodiments certainly exist.

Complementary pickguard pieces 24 may be used to fill in or otherwise complete the shape of the pickguard assembly 20. Consider the example in FIG. 1, where the electronic display 22 is rectangular, the sound hole 14 is circular, and the two components are adjacent one another so that the edge of display 22 is tangent the circular sound hole 14; this leaves a pair of generally triangular shaped spaces 24 disposed between the left edge of display 22 and the right edge of sound hole 14. Without complementary pickguard pieces 24, this area would be unprotected and could sustain damage from a guitar pick or other plectrum during strumming Thus, the complementary pickguard pieces 24 are used to geometrically complete or fill in the top surface 16 of the guitar body 12 in an area where the electronic display does not. It is possible for the complementary pickguard pieces 24 to be non-electronic (e.g., wood, plastic, laminate, brushed or other metal, etc.), or they may also be electronic and may operate independently or in conjunction with the main electronic display 22. These are, of course, only some of the possible embodiments.

Various types of mounting features 26 may be used to attach the pickguard assembly 20 to the guitar 10 or other stringed instrument. Pickguard assembly 20 may be directly or indirectly mounted to the body 12 of the guitar. In the case of direct mounting, the mounting features may include mechanical fasteners (e.g., screws, bolts, brackets, tabs, etc.) or some type of suitable adhesive so that the pickguard assembly 20 is directly mounted or otherwise affixed to a top surface 16 of the guitar body 12, without any intervening components or layers therebetween. In the example of FIG. 1, there are shown several mounting holes 26 in the pickguard assembly that allow for screws or bolts to secure the assembly to the guitar body. In the case of an indirect mounting arrangement, some type of sound damping or other acoustically significant component may be placed in between the pickguard assembly 20 and the body 12 of the guitar so that the pickguard assembly is acoustically isolated from the rest of the instrument and, thus, does not negatively impact its performance. It is possible for pickguard assembly 20 to be mounted in a complementary recess formed in the top surface 16 of the guitar body so that the top surface of the pickguard assembly is somewhat flush to the rest of top surface 16, or it may be mounted to a flat, non-recessed top surface 16 so that the pickguard assembly protrudes slightly from the rest of the guitar body top surface. Other mounting configurations and arrangements are certainly possible.

Turning now to FIG. 2, there is shown an exemplary embodiment of a pickguard assembly 120 installed on an electric guitar 110. Unlike its acoustic counterpart described above, pickguard assembly 120 has a multi-piece electronic display 122 and mounting features 126, where the display 122 includes several irregular shaped electronic display units 122₁-122₄ that may be arranged and wired to effectively function as one. Electronic display 122 can be adapted to accommodate different guitar body shapes and configurations as well as different components, such as by providing openings 130 so that one or more pickups, switches, knobs, audio jacks, etc. can pass through the display and be accessible to the musician. It is also possible to incorporate the guitar components directly into the pickguard assembly such that the assembly 10 actually includes the pickups or other electrical components; in this case, the incorporated components could be wired to the electronic display circuitry, such as that described above.

All of the components, devices, features, functions, etc. described above in conjunction with electronic display 22, complementary pickguard pieces 24, and mounting features 26 may be used with pickguard assembly 120 as well.

It should be appreciated that the acoustic and electric embodiments of FIGS. 1 and 2 have been provided simply to illustrate some of the possibilities of a pickguard assembly with an electronic display and are not limited to these particular examples. For instance, it is possible for the acoustic pickguard assembly 20 to have a multi-piece display and the electric pickguard assembly 120 to have a single piece display, or for the display screen of the acoustic pickguard assembly 20 to be non-regular in shape (i.e., non-rectangular) while the display screens of the electric pickguard assembly 120 are of conventional geometric shapes (e.g., rectangular, circular, oval, etc.). Furthermore, pickguard assemblies 20 and/or 120 may be designed to cover and/or replace a majority of or the entire body of the guitar, if desired, such that the mounting features are only used to attach various strings, knobs, or other acoustically functional parts. The pickguard assembly of the present application, whether for an acoustic guitar, an electric guitar or some other stringed instrument, may have a different size, may have a different shape and/or may be positioned in a different location than those illustrated in the drawings. For instance, it is possible for the pickguard assembly to be located further away from a sound hole or a set of strings than in the disclosed embodiments, so long as it covers at least a portion of the instrument body. These are, of course, only some of the possible implementations of the electronic pickguard assembly described herein, as others are certainly possible.

It is to be understood that the foregoing description is not a definition of the invention, but is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A pickguard assembly for a stringed instrument, comprising:
an electronic display including an electronic display screen coupled to and driven by electronic display circuitry; and
mounting features for attaching the electronic display to a body of the stringed instrument, wherein the pickguard assembly is configured to electronically change its visual appearance.

2. The pickguard assembly of claim 1, wherein the electronic display screen is selected from the group consisting of: a liquid crystal display (LCD), a light emitting diode (LED) display, an organic light emitting diode (OLED) display, a video graphics array (VGA) display, a plasma display, a printed display, a flexible display, or a touch screen display.

3. The pickguard assembly of claim 1, wherein the electronic display screen is located near a sound hole in an acoustic stringed instrument or near strings in an electric stringed instrument so that the electronic display screen only partially covers a top surface of the stringed instrument body.

4. The pickguard assembly of claim 1, wherein the electronic display screen entirely covers a top surface of the stringed instrument body.

5. The pickguard assembly of claim 1, wherein the electronic display includes a plurality of electronic display screens that are arranged next to one another on a top surface of the stringed instrument body and are configured to cooperate with one another so as to act as a single electronic display.

6. The pickguard assembly of claim 1, wherein the electronic display screen includes an opening that allows at least one of a pickup, a knob, a dial, a switch, a connector, a neck or a bridge to extend away from the stringed instrument and pass through the opening so that it is accessible to a user.

7. The pickguard assembly of claim 1, wherein the electronic display screen includes at least one of a pickup, a knob, a dial, a switch, a connector, a neck or a bridge of the stringed instrument directly incorporated into the electronic display screen so that it is accessible to a user.

8. The pickguard assembly of claim 1, wherein the electronic display screen includes a protective film or coating applied to a top surface so that the electronic display screen is more resistant to scratching, scuffing or other damage.

9. The pickguard assembly of claim 1, wherein the electronic display circuitry includes a user input that is configured to connect with a user device.

10. The pickguard assembly of claim 9, wherein the user input includes a wired port that is configured for a wired connection with the user device so that the user device can provide one or more electronic file(s) to the electronic display circuitry that electronically control the visual appearance of the pickguard assembly.

11. The pickguard assembly of claim 9, wherein the user input includes a wireless port that is configured for a wireless connection with the user device so that the user device can wirelessly provide one or more electronic file(s) to the electronic display circuitry that electronically control the visual appearance of the pickguard assembly.

12. The pickguard assembly of claim 1, wherein the electronic display circuitry includes an instrument interface that is configured to connect with the stringed instrument.

13. The pickguard assembly of claim 12, wherein the instrument interface is configured to connect with electronic circuitry of the stringed instrument so that the visual appearance of the pickguard assembly is synchronized with the user playing the stringed instrument.

14. The pickguard assembly of claim 12, wherein the instrument interface is configured to connect with electronic wiring of the stringed instrument so that power for the pickguard assembly is obtained from the stringed instrument.

15. The pickguard assembly of claim 1, wherein the electronic display is configured to connect with a battery so that power for the pickguard assembly is obtained from the battery.

16. The pickguard assembly of claim 1, wherein the electronic display circuitry includes a user switch that is configured to provide a user with control over the visual appearance of the pickguard assembly.

17. The pickguard assembly of claim 16, wherein the user switch is coupled to a foot pedal and is configured so that the user can electronically change the visual appearance of the pickguard assembly by engaging the foot pedal.

18. The pickguard assembly of claim 16, wherein the user switch is coupled to a touch screen that is attached to the stringed instrument and is configured so that the user can electronically change the visual appearance of the pickguard assembly by engaging the touch screen.

19. The pickguard assembly of claim 1, further comprising at least one complementary pickguard piece, wherein the electronic display screen and the complementary pickguard piece are attached to the stringed instrument body in the vicinity of a sound hole and are arranged so as to fill in or complete the shape of the pickguard assembly with respect to the sound hole.

20. A guitar comprising one or more guitar components and the pickguard assembly of claim 1.

21. A method of controlling the visual appearance of a stringed instrument, the method comprising the steps of:
displaying a first image or video on an electronic display of a pickguard assembly attached to the stringed instrument;
receiving an electronic input to change the visual appearance of the pickguard assembly; and
displaying a second image or video on the electronic display of the pickguard assembly in response to the electronic input, wherein the first and second images or videos are different so that the visual appearance of the stringed instrument changes without physically replacing the pickguard assembly.
